(19) United States
(12) Patent Application Publication
(10) Pub. No.: US 2016/0375444 A1
(43) Pub. Date: Dec. 29, 2016

(54) METHOD FOR CALCULATING THE PULSE FIRING PATTERN FOR A TRANSFORMER OF AN ELECTROSTATIC PRECIPITATOR AND ELECTROSTATIC PRECIPITATOR

(71) Applicant: General Electric Technology GmbH, Baden (CH)

(72) Inventors: Carl Marcus WILLIAMSSON, Ljungby (SE); Nanda Kishore DASH, Bhubaneswar Odisha (IN); Anders Nils Gustav KARLSSON, Vaxjo (SE); Inger Elisabeth Marcus ÖNNERBY PETTERSSON, Vaxjo (SE)

(21) Appl. No.: 15/184,144

(22) Filed: Jun. 16, 2016

(30) Foreign Application Priority Data
Jun. 29, 2015 (IN) 1921/DEL/2015

(51) Int. Cl. B03C 3/68; B03C 3/04

(52) U.S. Cl. CPC B03C 3/68; B03C 3/04

(57) ABSTRACT

The method for calculating the pulse firing pattern for a transformer of an electrostatic precipitator, the method comprising a) defining a target parameter indicative of the power to be supplied to collecting electrodes and discharge electrodes of the electrostatic precipitator, b) calculating a first parameter indicative of the power supplied to the collecting electrodes and discharge electrodes using the pulse firing pattern being calculated, in case one additional pulse is fired, c) calculating a second parameter indicative of the power supplied to the collecting electrodes and discharge electrodes using the pulse firing pattern being calculated, in case two additional successive pulses are not fired, d) selecting at least one pattern element on the basis of the first parameter or second parameter, e) repeating steps b), c), d), e).

### CROSS-REFERENCE TO RELATED APPLICATIONS

This application claims priority to Indian Patent Application No. 1921/DEL/2015 filed Jun. 29, 2015, the contents of which are hereby incorporated in its entirety.

### TECHNICAL FIELD

The present invention relates to a method for calculating the pulse firing pattern for a transformer of an electrostatic precipitator and electrostatic precipitator.

For example, the electrostatic precipitator is of the type used in a power plant or in an industrial application. Other applications with smaller electrostatic precipitators are anyhow possible.

### BACKGROUND

Electrostatic precipitators are known to comprise a filter connected to a transformer in turn connected to a rectifier. Typically the transformer and the rectifier are embedded in one single unit. The filter is connected to a power supply, such as to the electric grid; the rectifier is in turn connected to collecting electrodes and discharge electrodes.

During operation the filter receives the electric power from the electric grid (e.g. this electric power can have sinusoidal voltage and current course) and skips some of the half waves of the electric power (e.g. voltage or current) according to a pulse firing pattern, generating a pulsed power that is supplied to the transformer.

The pulse firing pattern is a sequence of first elements indicative of a pulse to be fired and second elements indicative of a pulse to be not fired. The pulse firing pattern is defined as a pulse period or pulse firing pattern length having one first element and an even number of second elements; the pulse period thus has an odd number of elements.

If the transformer is supplied with a pulsed power having two or more successive pulses of the same polarity (i.e. positive or negative), this would cause a risk of saturation of the transformer. For this reason the pulse firing patterns traditionally used have one first element and an even number of second elements.

In addition, traditionally supply of pulsed power was only done to adapt the power sent to the collecting electrodes and discharge electrodes to the properties of the flue gas (e.g. in terms of resistivity), whereas energy management (to regulate the power sent to the collecting electrodes and discharge electrodes) was done by regulating the amplitude of the pulses.

Nevertheless, since when using pulse firing patterns only some but not all power from the electric grid is supplied to the collecting electrodes and discharge electrodes, the pulse firing patterns limit the power supplied to the collecting electrodes and discharge electrodes.

FIGS. 1, 2a, 2b, 3a, 3b show the voltage or current supplied to the transformer.

FIG. 1 shows the case when no pulse firing pattern is applied and all power from the electric grid is supplied to the transformer. In particular, reference 1 identifies the voltage or current supplied from the grid to the filter and reference 2 the voltage or current supplied from the filter to the transformer. In this case 100% of the power from the electric grid is supplied to the transformer and thus to the collecting electrodes and discharge electrodes.

FIG. 2a shows the case when the pulse firing pattern of FIG. 2b is applied at the filter and only ⅓ of the power from the electric grid is forwarded to the transformer, while ⅔ of the power from the electric grid is blocked at the filter and not supplied to the transformer. Also in this case, reference 1 identifies the voltage or current supplied from the grid to the filter and reference 2 the voltage or current supplied from the filter to the transformer. The curly brackets 3 identify the pulse period or pulse firing pattern length. In this case 33% of the power from the electric grid is supplied to the transformer and thus to the collecting electrodes and discharge electrodes.

FIG. 3a shows the case when the pulse firing pattern of FIG. 3b is applied and ⅕ of the power from the electric grid is forwarded to the transformer and ⅘ of the power from the electric grid is blocked at the filter and not supplied to the transformer. In this case as well, reference 1 identifies the voltage or current supplied from the grid to the filter, reference 2 the voltage or current supplied from the filter to the transformer and the curly brackets 3 identify the pulse period or pulse firing pattern length. In this case 20% of the power from the electric grid is supplied to the transformer and thus to the collecting electrodes and discharge electrodes.

It is thus apparent that the step between use of no pulse firing pattern (FIG. 1) and use of the pulse firing pattern that allows supply of the largest power to the collecting electrodes and discharge electrodes (FIG. 2a, 2b) corresponds to 67% of the power supplied from the electric grid.

This large power step could not allow optimal operation, because only in case the features of the gas being treated allow supply of the collecting electrodes and discharge electrodes with only 33% of the power supplied from the grid it is possible the use of pulse firing pattern; if use of 33% of the power from the grid is not possible in view of the features of the gas being treated, it is needed operation without pulse firing pattern. In other words, if the features of the gas could require use of a pulse firing pattern corresponding to e.g. 50% of the power from the electric grid, it is not possible operation with the pulse firing pattern, because use of the pulse firing pattern would allow supplying the collecting electrodes and discharge electrodes with only 33% of the power from the electric grid. It would thus be needed operation without pulse firing pattern.

In addition, power regulation made via amplitude reduction (of voltage and/or current), as traditionally done, affects the corona discharge from the discharge electrodes and thus negatively affects dust charging (that occurs via corona) and therefore dust collection at the collecting electrodes.

### SUMMARY

An aspect of the invention includes providing a method and an electrostatic precipitator that allow an improvement of the regulation of the power supplied to the collecting electrodes and discharge electrodes. Advantageously according to the invention fine regulation can be achieved.

These and further aspects are attained by providing a method and an electrostatic precipitator in accordance with the accompanying claims.

Advantageously, amplitude regulation (voltage and/or current) is not needed for regulation, such that amplitude regulation does not affect or can be made to affect to a limited extent the corona discharge.

### BRIEF DESCRIPTION OF THE DRAWINGS

Further characteristics and advantages will be more apparent from the description of a preferred but non-exclusive embodiment of the pulse firing pattern and electrostatic precipitator, illustrated by way of non-limiting example in the accompanying drawings, in which:

FIG. 1 shows the voltage or current entering and moving out of a filter when no pulse firing pattern is used (prior art);

FIG. 2a shows the voltage or current entering and moving out of a filter when the pulse firing pattern shown in FIG. 2b is used (prior art);

FIG. 2b shows a pulse firing pattern (prior art);

FIG. 3a shows the voltage or current entering and moving out of a filter when the pulse firing pattern shown in FIG. 3b is used (prior art);

FIG. 3b shows a pulse firing pattern (prior art);

FIG. 4 shows an electrostatic precipitator;

FIG. 5 shows the voltage or current at different positions of the electrostatic precipitator.

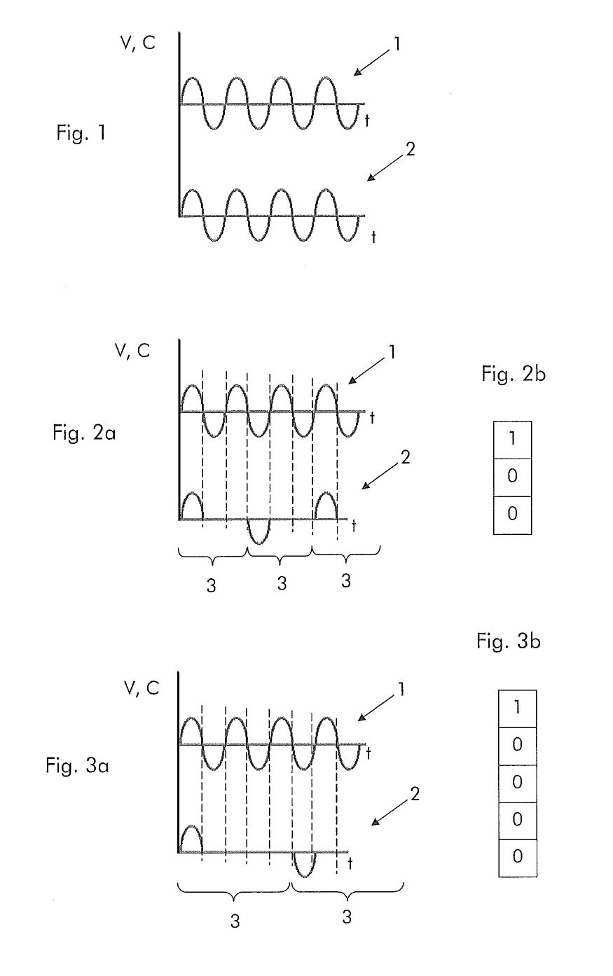

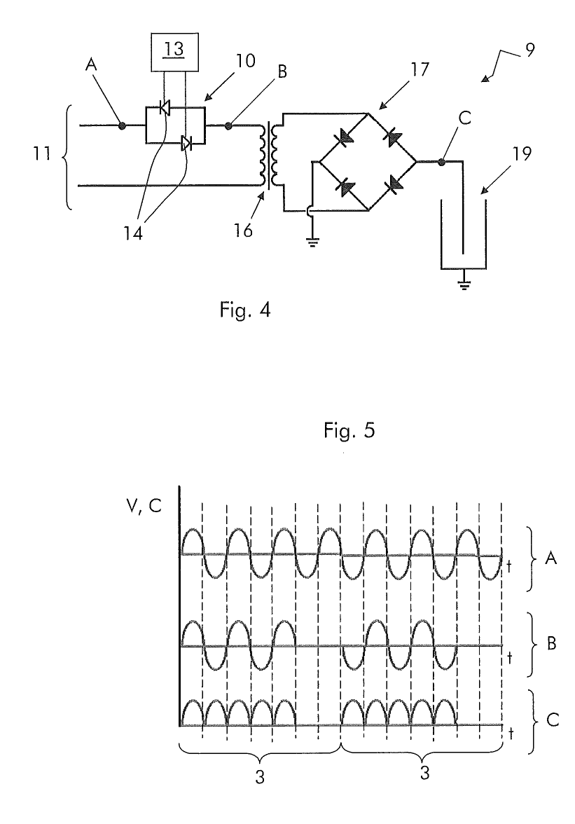

### DETAILED DESCRIPTION

In the following the electrostatic precipitator is described first.

The electrostatic precipitator 9 comprises a filter 10 connected to a power input 11; the filter 10 is arranged for filtering an input power from the power input 11, generating a pulsed power according to a pulse firing pattern.

A control unit 13 is connected to the filter 10 in order to drive it and implement the pulsed firing pattern. For example, the filter can comprise transistors or other types of electronic switches 14.

A transformer 16 is connected to the filter 10; the transformer 16 is arranged for transforming the pulsed power from the filter 10 into a transformed pulsed power.

A rectifier 17 is connected to the transformer 16; the rectifier 17 is arranged for rectifying the transformed pulsed power generating a rectified pulsed power.

Collecting electrodes and discharge electrodes 19 are connected to the rectifier 17 for receiving the rectified pulsed power. The collecting electrodes and discharge electrodes 19 are immersed in a path where the flue gas to be cleaned passes through.

The control unit 10 drives the electronic switches 14 to pass to an electric conductive state or electric non-conductive state according to the pulsed firing pattern. The pulse firing pattern comprises:
first elements indicative of a pulse to be fired; these elements are indicated as “1” ;
second elements indicative of a pulse to not be fired, these elements are indicated as “0”.

FIG. 5 shows the voltage or power at different positions A, B, C of the electrostatic precipitator 9.

The power input 11 (e.g. electric grid) supplies electric power whose voltage or current has e.g. sinusoidal course (FIG. 6, position A). At the filter 10 only the half waves in correspondence of a “1” of the pulsed firing pattern are allowed to pass through, whereas half waves in correspondence of “0” of the pulse firing pattern are blocked.

FIG. 5, position B shows the voltage or current downstream of the filter 10 and upstream of the transformer 16.

After the transformer, the electric power is rectified at the rectifier 17; FIG. 5, position C shows the voltage or current downstream of the rectifier 17.

Since according to the method any desired or required power can be obtained by calculating the pulse firing pattern, power regulation by amplitude regulation is not needed.

The method for calculating the pulse firing pattern for a transformer of an electrostatic precipitator comprises:
a) defining a target parameter indicative of the power to be supplied to the collecting electrodes and discharge electrodes 19;
b) calculating a first parameter indicative of the power supplied to the collecting electrodes and discharge electrodes 19 using the pulse firing pattern being calculated, in case one additional pulse is fired,
c) calculating a second parameter indicative of the power supplied to the collecting electrodes and discharge electrodes 19 using the pulse firing pattern being calculated, in case two additional successive pulses are not fired,
d) selecting pattern elements between one first element or two second elements on the basis of the first parameter or second parameter,
e) repeating steps b), c), d), e).

Selecting pattern elements can be done:
on the basis of which parameter between the first parameter or second parameter falls closer to the target parameter or, in case this is not possible, because e.g. none of the first parameter or second parameter falls closer to the target parameter (e.g. the first parameter and second parameter have the same distance from the target parameter)
a given pattern element can be selected; e.g. in this case the pattern element “1” could be selected; alternatively it is also possible to select the pattern element “0”.

As for the step e), it is also possible that the step e) also comprises repeating the step a) in addition to repeating steps b) though e).

In this embodiment the target parameter can be supplied to e.g. the control unit 13 in any moment, such that the pulse firing pattern that is implemented in the electrostatic precipitator allows a power transfer to the collecting electrodes and discharge electrodes 19 always moving towards the target parameter.

The continuous repetition can be implemented by defining a pattern period or pulse firing pattern length and calculating the first parameter and the second parameter on the basis of the pattern period or pulse firing pattern length.

For example, a start and an end can be defined in the pulse firing pattern; the start corresponds to the element added first to the pulse firing pattern and the end to the element added last to the pulse firing pattern, i.e. the additional elements are added to the end of the pulse firing pattern.

Thus, calculating the first parameter and the second parameter on the basis of the pattern period can comprise:
calculating the first parameter indicative of the power supplied to the electrostatic precipitator using a pulse firing pattern having
   the defined pulse period or pulse firing pattern length, and
   one additional first element at the end, and
   deprived of one element at the start;
calculating a second parameter indicative of the power supplied to the electrostatic precipitator using a pulse firing pattern having
   the defined pulse period, and
   two additional second elements at the end, and
   deprived of two elements at the start.

Naturally continuous re-calculation (implementing by the feature e) above) can also be implemented without repeating the step a).

In the following an example of implementation of the method is described in detail. In this example it is supposed that the pattern period or pulse firing pattern length is equal to 5 (this is only a simplification, in real cases the pattern period can be in the order of thousand or ten of thousand, e.g. 10000 or more; a long pattern period or pulse firing pattern length helps matching the power associated with the pulse firing pattern being calculated with the target parameter e.g. up to two decimals or with even more accuracy). In the following example step a) is not repeated.

STEP a)

A target parameter of e.g. 50% of the power supplied from the grid and to be supplied to the collecting electrodes and discharge electrodes 19 is defined.

The target parameter can be defined on the basis of the features of the gas to be cleaned and/or can be manually entered; for example the gas comes from a power plant or industrial plant.

At this stage the pulse firing pattern does not include any first elements “1” or second elements “0”.

STEP b)

In case one additional pulse is fired (i.e. a pulse firing pattern “1” is implemented such that all power from the power input 11 is forwarded to the transformer 16) 100% of the power from the power input 11 is supplied to the electrodes 19.

STEP c)

In case two additional pulses are not fired (i.e. a pulse firing pattern “0,0” is implemented) 0% of the power from the power input 11 is supplied to the electrodes 19.

STEP d)

The element “1” corresponding to 100% power is selected for the pulse firing pattern; therefore after a first cycle the pulse firing pattern being calculated is: “1”. One pulse can thus be forwarded to the collecting electrodes and discharge electrodes 19.

STEP e) (First Repetition STEP b)

In case one additional pulse is fired (i.e. a pulse firing pattern “1,1” is implemented and also in this case all the power from the power input 11 is forwarded to the transformer 16) 100% of the power from the power input 11 is supplied to the electrodes 19.

STEP e) (First Repetition STEP c)

In case two additional pulses are not fired (i.e. a pulse firing pattern “1,0,0” is implemented) 33% of the power from the power input 11 is supplied to the electrodes 19.

STEP e) (First Repetition STEP d)

The element “0,0” corresponding to 33% power is selected for the pulse firing pattern that; therefore after a first cycle the pulse firing pattern being calculated is: “1,0,0”. Two pulses are thus not forwarded to the collecting electrodes and discharge electrodes 19.

STEP e) (Second Repetition STEP b)

In case one additional pulse is fired (i.e. a pulse firing pattern “1,0,0,1” is implemented) 50% of the power from the power input 11 is supplied to the electrodes 19.

STEP e) (Second Repetition STEP c)

In case two additional pulses are not fired (i.e. a pulse firing pattern “1,0,0,0,0” is implemented) 20% of the power from the power input 11 is supplied to the electrodes 19.

STEP e) (Second Repetition STEP d)

The element “1” corresponding to 50% power is selected for the pulse firing pattern that, after a second cycle, is: “1,0,0,1”. One pulse can thus be forwarded to the collecting electrodes and discharge electrodes 19.

STEP e) (Third Repetition STEP b)

In case one additional pulse is fired (i.e. a pulse firing pattern “1,0,0,1,1” is implemented) 60% of the power from the power input 11 is supplied to the electrodes 19.

STEP e) (Third Repetition STEP c)

In case two additional pulses are not fired (i.e. a pulse firing pattern “0,0,1,0,0” is implemented) 20% of the power from the power input 11 is supplied to the electrodes 19.

STEP e) (Third Repetition STEP d)

The element “1” corresponding to 60% power is selected for the pulse firing pattern; therefore after the third cycle the pulse firing pattern being calculated is: “1,0,0,1,1”. One pulse can thus be forwarded to the collecting electrodes and discharge electrodes 19.

STEP e) (Fourth Repetition STEP b)

In case one additional pulse is fired (i.e. a pulse firing pattern “0,0,1,1,1” is implemented) 60% of the power from the power input 11 is supplied to the electrodes 19.

STEP e) (Fourth Repetition STEP c)

In case two additional pulses are not fired (i.e. a pulse firing pattern “0,1,1,0,0” is implemented) 40% of the power from the power input 11 is supplied to the electrodes 19.

STEP e) (Fourth Repetition STEP d)

The given element “1” corresponding to 60% power is selected for the pulse firing pattern that, after a fourth cycle, is: “0,0,1,1,1”. One pulse can thus be forwarded to the collecting electrodes and discharge electrodes 19.

The steps are b) through e) are then continuously implemented.

Therefore, the pulse firing pattern can be continuously generated. This allows to reach a pulse firing pattern that is equal to the target parameter or as close as possible to the target parameter. In addition this allows to change the target parameter and define a pulse firing pattern matching or close to the target parameter.

In case also step a) in the example above is repeated, the process remains the same, with the only different that the target parameter is changed.

The control unit 13 implements the method and preferably has a computer readable memory medium containing instructions to implement the method.

Naturally the features described may be independently provided from one another.

1. A method for calculating a pulse firing pattern for a transformer of an electrostatic precipitator, the method comprising:
a) defining a target parameter indicative of power to be supplied to collecting electrodes and discharge electrodes of the electrostatic precipitator;
b) calculating a first parameter indicative of the power supplied to the collecting electrodes and discharge electrodes using the pulse firing pattern being calculated, in case one additional pulse is fired;
c) calculating a second parameter indicative of power supplied to the collecting electrodes and discharge electrodes using the pulse firing pattern being calculated, in case two additional successive pulses are not fired;
d) selecting at least one pattern element based on the first parameter or second parameter; and
e) repeating steps b), c), d), and e).

2. The method of claim 1, wherein selecting at least one pattern element comprises selecting a parameter between the first parameter or second parameter that falls closer to the target parameter.

3. The method of claim 1, wherein selecting at least one pattern element comprises selecting a given pattern element when the first parameter and second parameter are equally distanced from the target parameter.

4. The method of claim 1, wherein step e) also comprises repeating step a).

5. The method of claim 1, further comprising:
f) defining a pulse firing pattern length; and
g) calculating the first parameter and the second parameter based on the pulse firing pattern length.

6. The method of claim 1, further comprising:
h) defining a pulse firing pattern length; and
i) calculating the first parameter and the second parameter based on the pulse firing pattern length;
wherein the pulse firing pattern has a start and an end, wherein additional elements are added to the end of the pulse firing pattern; and
wherein calculating the first parameter and the second parameter based on the pulse firing pattern length comprises
calculating a first parameter indicative of power supplied to the electrostatic precipitator using a pulse firing pattern having the pulse firing pattern length and one additional first element and deprived of one element at the start, and
calculating a second parameter indicative of power supplied to the electrostatic precipitator using a pulse firing pattern having the pulse firing pattern length and two additional second elements and deprived of two elements at the start.

7. A computer readable memory medium containing instructions to implement the method of claim 1.

8. An electrostatic precipitator comprising:
a filter connected to a power input, the filter for filtering an input power generating a pulsed power according to a pulse firing pattern;
a control unit connected to the filter;
a transformer connected to the filter, the transformer for transforming the pulsed power into a transformed pulsed power;
a rectifier connected to the transformer, the rectifier for rectifying the transformed pulsed power generating a rectified pulsed power; and
collecting electrodes and discharge electrodes connected to the rectifier for receiving the rectified pulsed power;
wherein the control unit is arranged to implement a method according to claim 1.

9. The electrostatic precipitator according to claim 8, wherein after step d) and before step e) the control unit implements the pattern element.

10. The electrostatic precipitator according to claim 8, further comprising a computer readable memory.
